(19) United States
(12) Patent Application Publication
(10) Pub. No.: US 2009/0063503 A1
(43) Pub. Date: Mar. 5, 2009

(54) METHOD AND SYSTEM FOR REMOTE CACHE ACCESS

(76) Inventor: Kevin Ward, Waterloo (CA)

Correspondence Address: BERESKIN AND PARR, 40 KING STREET WEST, BOX 401, TORONTO, ON, M5H 3Y2, CA

(21) Appl. No.: 11/850,441

(22) Filed: Sep. 5, 2007

(51) Int. Cl. G06F 17/30

(52) U.S. Cl. 707/10; 707/E17.008

(57) ABSTRACT

A method of processing a request associated with an electronic document in a document management system at a local replicated system, the method comprising the steps of first receiving the request. The method further comprises determining whether the request is a read only request that may be processed at a local replicated system; routing the request to either a master document management server or a local replicated system; and monitoring the local replicated systems to determine whether subsequent transactions may be processed at the local replicated systems.

### FIELD

The embodiments described herein relate generally to document management systems, and more specifically to improved methods and systems for accessing content associated with document management systems.

### BACKGROUND

Due to the large volume of documents that are associated with many organizations, it has become increasingly necessary to devise methods by which large volumes of data may be organized and accessed. One method involves the use of document management systems.

Document management systems had initially been developed to capture images of electronic documents. Users of the system were able to access the document images that were stored on a central server.

Document management systems have now developed to where they are used to store the actual electronic document that is created and for which access is required. Document management systems must be designed to ensure that they have the ability to index the electronic documents, store the electronic documents and provide access to respective users of the electronic documents.

As large organizations that may have facilities distributed across many countries make use of document management systems to manage their electronic documents, it has become necessary that methods and systems be developed to provide remote access to the system. Currently, users of document management systems may access the electronic documents through various methods including establishing a dedicated link to the central document management server, and accessing the document management system through the Internet.

Regardless of the type of network communication that is employed, users of document management systems require that their requests for documents or for certain operations (i.e. retrieving a previously viewed document, or logging in) be performed in a timely and efficient manner.

Users of the same document management system may be met with differing response times for their requests. One reason for such delayed response times may be due to the geographic locations of the requesting users and the limitations that may be associated with their connectivity to the respective network.

One solution that has been devised to help: increase the speed at which electronic documents are provided to users, is to make use of repositories of commonly accessed documents, or caches. The respective caches store electronic documents at a user's site that may be requested by the user. Therefore, when a request is made for an electronic document a check is performed to determine whether this electronic document is available to the user from a cache that would serve the user's request faster.

Through the implementation of caches, users are often provided with faster response times with respect to their document requests. However, many requests which are fulfilled by providing documents to the user from a cache still require interaction with a central server for the appropriate access to be granted. Therefore, even a simple read request in a document management system that makes use of remote cache may not be much faster than a read request that is fulfilled without the use of a cache.

### SUMMARY

In one aspect of the invention a method for determining where a request related to an electronic document received from a client device in a document management system should be processed is provided. The method comprises determining whether the request is a read only request that may be processed at a local replicated system; routing the request to either a master document management server or a local replicated system; and monitoring the local replicated systems to determine whether subsequent transactions may be processed at the local replicated systems.

In another aspect of the invention, a method of processing a request associated with an electronic document in a document management system at a remote site associated with a document management system is provided. The method comprises the steps of: (a) receiving the request; determining if the request is a read-only request; determining if a previous write operation has been completed; processing the request at the local replicated system where the determinations made at steps (b), (c) are true, and processing the request at a master server where one of the determinations made at steps (b), or (c) are false.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of a conventional document management system;

FIG. 2 is a block diagram of document management system illustrated in an exemplary embodiment;

FIG. 3 is a flowchart diagram illustrating steps of a request processing method;

FIG. 4 is a block diagram illustrating the interaction between a request and components of the document management system in an exemplary embodiment;

FIG. 5 is a flowchart diagram illustrating the steps of a write/update method; and

FIG. 6 is a flowchart diagram illustrating the steps of a remote cache access method.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers, each comprising at least one processor, a data storage system (including volatile and non-volatile memory and/or storage elements), at least one input device, and at least one output device. For example and without limitation, the programmable computer may be a mainframe computer, server, personal computer, laptop, personal data assistant, or cellular telephone. A program code is applied to input data to perform the functions described herein and generate output information. The output information is applied to one or more output devices, in known fashion.

Each program is preferably implemented in a high level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette), readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

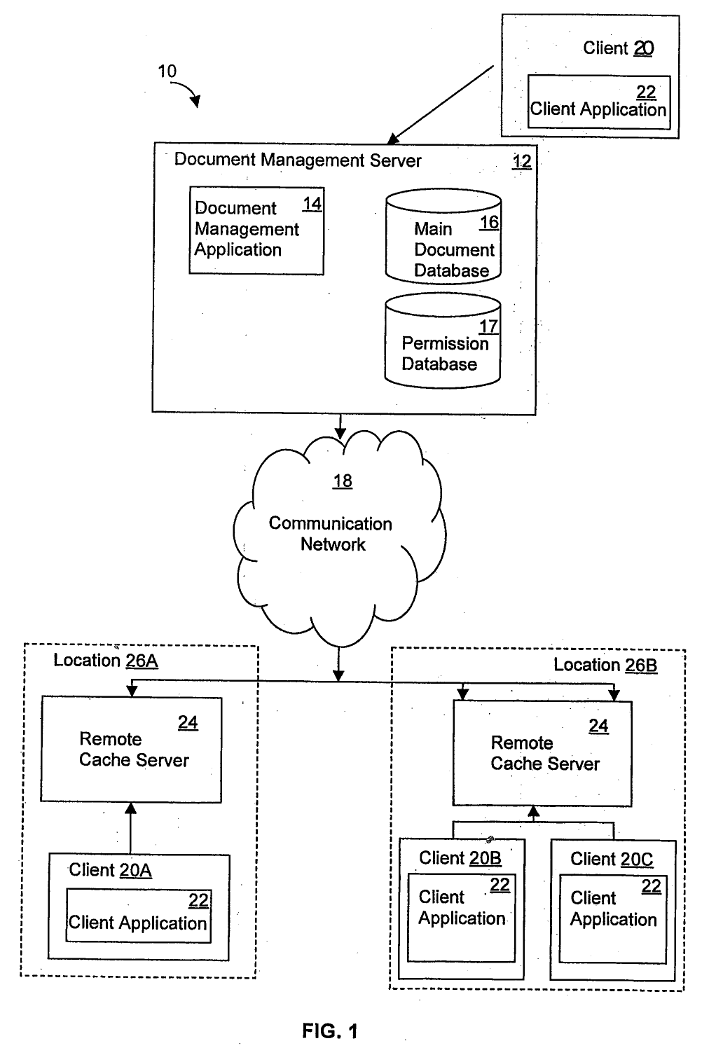

Reference is now made to FIG. 1 which illustrates one embodiment of components in a conventional document management system 10. Document management system 10 allows for the storage and retrieval of electronic documents by users who are in various geographic locations. The electronic documents may be any type of electronic files that may be shared between users. Document management system 10 also provides functionality to the users allowing them to engage in collaborative discussions with other users regarding the respective electronic documents. Further, the document management system allows users to track the history of a document, including when it was created, accessed and last edited. Examples of document management systems that are currently available include, but are not limited to, Livelink, Microsoft Sharepoint, EMC and Filenet.

The conventional document management system 10 comprises a document management server 12, a document management application 14, a main document database 16, a metadata/permission database 17, a communication network 18, and one or more client devices 20.

The document management server 12 has resident upon it, or accessible to it, the document management application 14, the main document database 16 and the metadata/permission database 17. The server 12 is a server-type computing device that allows for a connection to a network 18 which therefore allows a remote client device 20 access to the server 12.

The server 12 and, more specifically, the document management application 14, receives and processes requests for electronic documents that are stored in the database 16. The document management application 14 determines the access requirements and access parameters that are associated with each user and each document, and then either allows or denies a request.

The main document database 16 stores electronic documents that are associated with the document management system 10. The documents may be any electronic file that one or more users wish to access through use of the system 10. The main document database 16 may also be implemented as a link to an electronic file system.

The metadata database 17 stores the respective metadata that is associated with the electronic documents that are stored in the document database 16. The metadata database 17 includes information relating to the permissions associated with each document and who may access the respective documents. The metadata database also includes other information relating to the document including details regarding the owner of the document, the data, unique ID and information (pointers) regarding where the documents are stored, along with or other user or system defined metadata.

The communication network 18 is any type of network that allows for communication between client and server devices. The communication network 18 may include, but is not limited to a local area network (LAN), a wide area network (WAN), the Internet or the Intranet.

The client device 20 may be any type of computing device that can access the document management server 12. One or more client device 20, respectively, may be part of the document management system 10. Examples of a client device 20 include but are not limited to, personal computers, laptop computers, slim line computers, server based computers, handheld computers, and any other such device that is able to provide an interface and connect to the server 12 through a communication network. Each client device 20 has an output device (not shown) such as a monitor or screen associated with it for viewing the respective documents from the database 16 and for engaging with the respective document. Each client device 20 also is associated with an input device (not shown) that allows the user to make requests for the various documents.

The client device 20 may have associated with it a client application 22. The client application 22 allows the client device 20 to connect to the document management server 12. The client application may be a dedicated application that is installed upon the client device 20 for purposes of giving the user access to the document management server 12. In an exemplary embodiment, the client application 22 may also be a web browser, where the user may access the server through a conventional web-based interface.

Each client device 20 may have access to a remote cache server 24. The remote cache server 24 allows for distributed document caching and routes document requests to a file system cache (not shown). The remote cache server 24 routes requests for metadata to the metadata databases. The remote cache server 24 has access to copies of documents that have been recently requested by one or more client devices 20. The respective client device 20 may be physically present in different geographic locations 26. As the client device 20 accesses the document management server 12 through the Internet in many instances, the client device 20 itself may be located in any location with Internet access.

In this embodiment of the conventional document management system 10, any request made by a user of a client device 20 for any document is received at the document management server 12. The document management server 12, upon receiving a request, makes a determination as to whether the user that is making the request has the appropriate permissions. Therefore, even where a document is being requested that may be resident on the remote cache server that is located at the user's location 26, the request is first transmitted to the respective document management server 12 for processing including permission checking. Therefore, with the conventional document management systems, all requests made by the user are transmitted to the central server for processing. As such requests are processed firstly at the central server, the requesting user is met with increased response times with respect to their transaction requests. All requests from users in remote locations are handled by the remote cache server. Where a user is not in a remote location, the user's client device may connect directly with the management server 12.

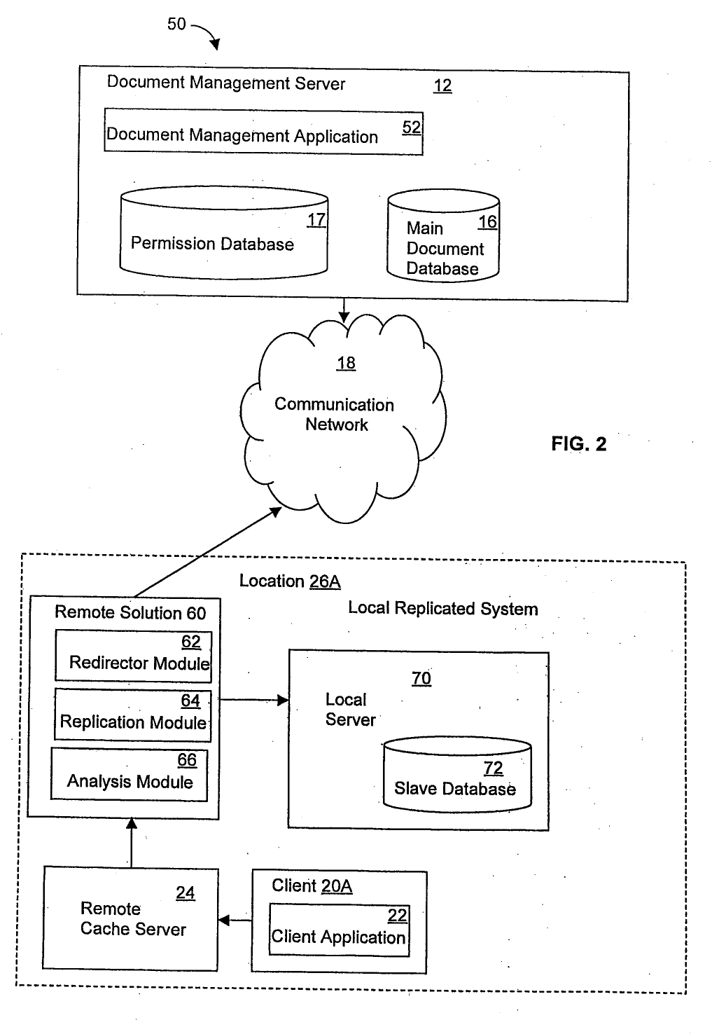

Reference is now made to FIG. 2, where an advanced cache document management system 50 is shown in an exemplary embodiment. The system 50, as shown in the exemplary embodiment, allows users located in various geographic locations to access documents associated with the management server 12. The document management system 50 provides the users with faster response times with respect to the read requests that are made by the users. Read requests may be any operation that does not require an update or write operation to be performed upon any of the electronic documents.

The document management system 50 has resident upon the management server 12 a document management application 52, a permission database 17 and a main document database 16. The document management application 52 allows consistency through replication of the respective databases that are stored on the server and that have replicas that may be accessed at the respective remote locations.

The respective client device 20 at a remote location 26A may access the management server 12 through a communication network 18.

The remote application 60 receives the requests that are made by users of the system 50. As described above, the users of the system 50 may wish to perform various operations. For purposes of example, the operations that a user of the document management system 50 may perform are described in relation to a document management system that is implemented through the Internet and specifically through Livelink in an exemplary embodiment. Examples of such operations may include, but are not limited to, read, write, update and browse operations. Where the system is web-based, as in the exemplary embodiment, read operations include, but are not limited to, browse operations, download operations, and retrieve operations.

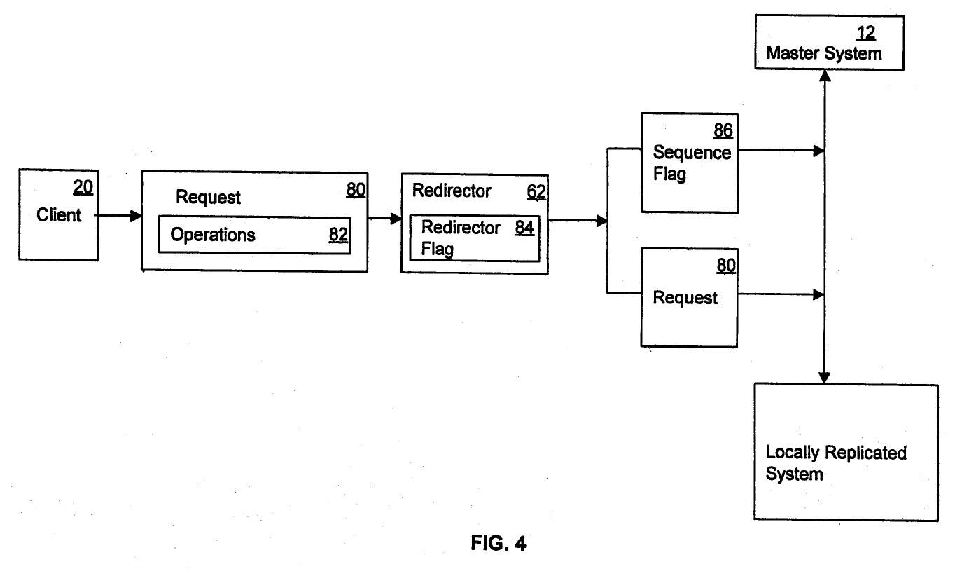

The remote application 60 in an exemplary embodiment has associated with it a redirector module 62, a replication module 64 and an analysis module 66. The operation of the respective modules will be described in further detail with regard to FIGS. 4 to 6.

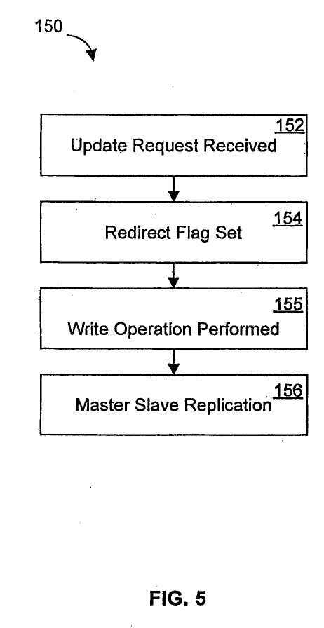

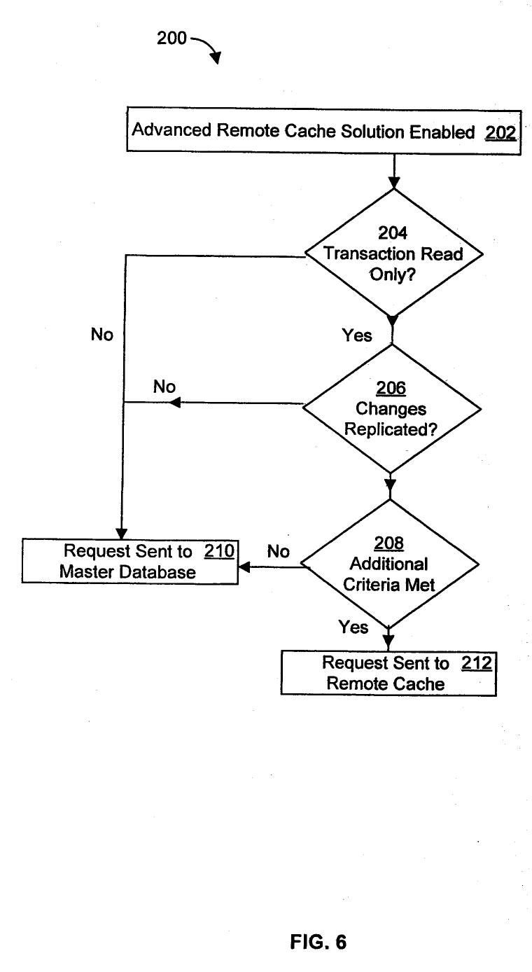

The redirector module 62 determines, based on the request made by the user, whether the request should be processed locally or whether it should processed at the management server 12 for processing. The operation of the redirector module will be described in further detail with regard to FIG. 5 and FIG. 6.

The replication module 64 ensures consistency between the master and slave databases. The replication method in an exemplary embodiment involves the user of SQL replication techniques. Consistency between the master database and the slave database is ensured with regard to the various metadata that is associated with the electronic documents. The replication module 64 also ensures that read operations are not performed while a write operation has not been completed. By ensuring that a read request may not be processed at a local system while a write operation has not been completed, ensures that the user is provided with accurate data. The term localized system is used to refer to the remote locations 26 that have access to a remote cache server 24, the remote application 60, the local document management server 70 and the local slave database 72, which are explained in detail below

The analysis module 66 receives the requests and analyses the request to determine the various operations that may be associated with the request. For example, one request may have associated with it various operations that may be a combination of read and write operations. The analysis module 66 receives the request and interacts with the other respective modules to ensure that the requests are appropriately processed.

Each remote cache server 24 has access to a slave database 72 through a local document management server 70. Generally, in an exemplary embodiment, one slave database 72 may be implemented in each local system or respective remote location. As an example, where a corporation has a head office where the master server 12 is located, the respective offices that have clients that connect to the head office for purposes of accessing the document management system 50 may have access to a slave database 72 through the remote cache server and the remote application 60. The slave database 72 comprises a subset of the data that is contained in the metadata database 17. The slave database 72 in an exemplary embodiment is comprised of the same data records for each respective location. This is contrasted with the remote cache (not shown) that is associated with each remote server 24 used at each location 26A or local system that only stores a subset of documents from the main database 16. Specifically, the remote cache stores locally accessed or locally created files that differ from location to location.

Documents that are stored in the remote cache are accessed if it is determined that the user has requested a read only operation and the respective checks to facilitate this transaction are performed locally. This method is described in further detail below.

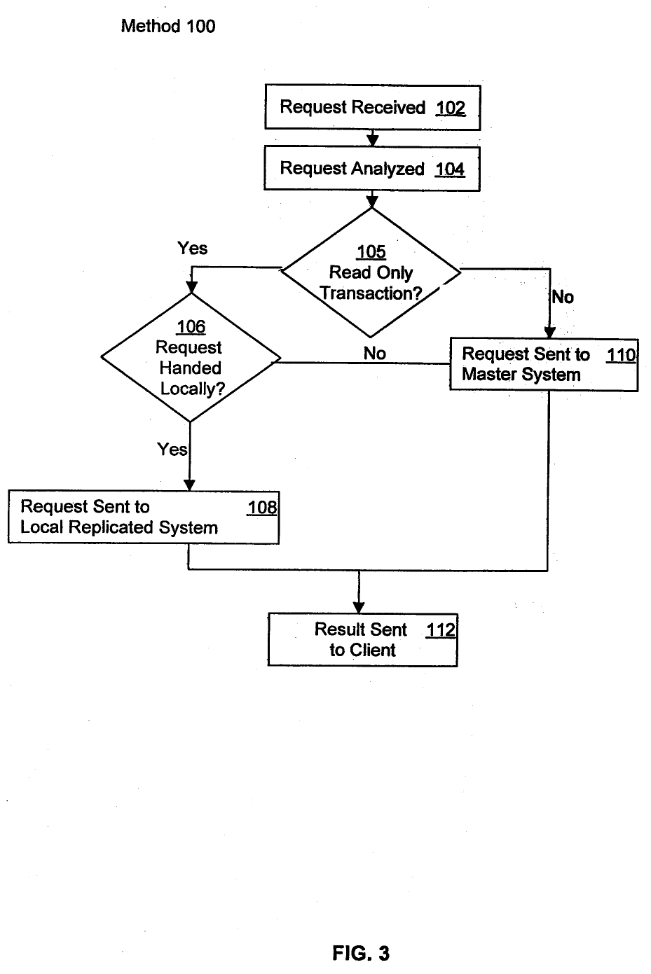

Reference is now made to FIG. 3, where a flowchart diagram illustrates the basic operational steps 100 of a request processing method are shown in an exemplary embodiment. Method 100 is explained with reference to users who are accessing the system 50 from a remote location. Where a user makes a direct connection to the document management server 12, their requests will be processed at the document management server 12. Operational steps 100 begin at step (102), where a user makes a request of the system 50 for an operation to be performed. Specifically, the request may comprise any operations that are supported by the document management system 50.

At step (104), the request is received at, and analyzed by the remote application 60, and more specifically by the analysis module 66. The request is not transmitted directly to the document management server 12. The remote application 60 receives the request before any subsequent processing is performed. At step (105), the request is transmitted to the re-director module 62. The re-director module 62 is able to determine whether a transaction request comprises only read-transactions or whether the transaction request comprises a write operation. In an exemplary embodiment, a read only table or database is stored at the remote location 26A which as mentioned above may also be referred to as the local replicated system. The read only database in an exemplary embodiment stores a list of transactions that are read only and that therefore may be performed at the local replicated system. The master for this respective database is stored at the master document management server 12 and replicated to the local systems. If it is determined at step (105) that the transaction request is a read only transaction, step (106) is executed. At step (106) a check is performed to determine whether the read only transaction request may be handled locally without requiring that a request is made to the server 12. The processing of step (106) determines whether the appropriate pre-processing steps have been completed to allow for the read transaction to be processed. The specific operations that are carried out at step (106) are described in further detail with regards to FIG. 6.

If it is determined at step (105) that the transaction request involves operations that involve write or update transactions, method 100 proceeds to step (110), where the requests are processed at the master document management server 12. At step (106), if it is determined even though the transaction is a read only request that it may not be processed locally, then method 100 proceeds to step (110). At step (110) the transaction is executed at the master database 16. When a document is retrieved from the master database 16, a copy is stored at the remote cache. Where an update that is performed at the master document management server 12 requires locally stored databases or tables to be updated, the locally stored database or tables have the respective data updated through replication.

If it is determined at step (106) that the request may be processed locally, method 100 then proceeds to step (108), where the request is processed at the local replicated system.

At the completion of steps (108) or (110), the requests are processed and the respective results are available to the user.

Reference is now made to FIG. 4, where a block diagram illustrating the path that a request takes from the client 20 in an exemplary embodiment. The request originates from a client device 20 based on a request made by the user or the client device 20 itself. The client generates a request 80 based on the requirements of the client 20 or the specification of the user. The request comprises one or more operations 82. The operations 82 may be any operation that may be performed on the electronic documents associated with the system 50.

The request is then received at the remote application 60, and is processed by the redirector module 66. The redirector module 66 has associated with it a redirector flag 86. The redirector flag 86 is used to indicate that the respective write operations that are being performed at the master database 16 have not been replicated at the respective replicated local system. Therefore, if a read request is processed at the local replicated system while a write request has not been fully replicated, the result of the read operation may yield an inaccurate result. The use and method of setting the respective redirector flag is illustrated in further detail with regards to FIG. 5. The redirector module 66 then causes the request 80 and its associated operations to be processed at either the master document management server 12 or the local replicated systems. The methodology employed by the redirector module is explained in further detail below with regards to FIG. 6.

In one embodiment, sequence values are used to determine whether write operations have been replicated at the respective databases. Specifically, in one exemplary embodiment, upon the execution of each write operation, the master document management server 12 assigns and keeps track of sequence values that are used to determine whether changes to the master database 16 have been replicated to the respective local replicated systems. The sequence values are incremented each time an update is to be performed and distributed to the local systems. When the update has been performed at the local replicated system, the local sequence value is incremented. When the sequence value at the local replicated system is less than that of the sequence value at the master database 16, this indicates that the changes have not been replicated.

Reference is now made to FIG. 5 and the steps of an update method 150 that are shown in an exemplary embodiment. The update method 150 is implemented where a request that is made by the user involves write or update operations, and therefore an update must be made to the respective master database 16. Method 150 begins at step (152) where it is determined that an update/write request has been made. After it has been determined that an update request has been made, method 150 then proceeds to step (154). At step (154), the redirect flag 84 is set. The redirect flag 84 indicates that a write operation is being performed, and that it has not been completed in its entirety. The system will consider a write or update operation to have been completed in its entirety when the write operation that is being performed has been replicated to the respective local replicated system associated with the user. Method 150 then proceeds to step (155) where the respective write operation is performed upon the master database 16. Method 150 then proceeds to step (156) where a one-way master slave replication process takes place. The master slave replication ensures that the update operation performed on the respective master database is replicated across the respective databases. The sequence values as described above are made use of in this process of tracking whether the write or update operations have been fully replicated. At the conclusion of the master slave replication process, the redirect flag 84 is set to indicate that no write operations remain to be performed. When the redirect flag 84 indicates that no write operations remain to be performed upon the respective databases, subsequent read operations may then be processed at the local replicated systems.

Reference is now made to FIG. 6, where a flowchart illustrating the steps of a local system access method 200 is shown in an exemplary embodiment. The local system access method 200 as described herein illustrates the steps that are executed at step (104) as shown in FIG. 3. Specifically, once it has been determined that the operation is a read only operation, it is then determined whether the request may be carried out at the local system. Therefore, method 200 begins at step (202), where a check is performed to determine if the appropriate processing methods are enabled.

Method 200 then proceeds to step (204) to determine whether the transaction is a read-only transaction. The method of determining whether a transaction is a read only transaction has been previously described in one embodiment through the use of look-up tables that store read only requests. If it is determined that the transaction is read only, method 200 proceeds to step (206) where a check is performed to determine whether any of write operations remain to be written. If the transaction is not a read only transaction, method 200 proceeds to step (210). As referenced with regards to method 150 as shown in FIG. 5, a flag is set to indicate that write operations remain to be performed. Where the flag indicates that write operations are remaining, step (204) causes method 200 to proceed to step (210). At step (210), the requested read operation is undertaken at the master database 16.

If it is determined at step (206) that all of the changes from the previous write operation have been replicated to the respective databases, method 200 proceeds to step (208). At step (208) a check is performed to determine whether the additional criteria are met. Additional criteria may be any additional checks that may be performed that can be expanded based on user defined criteria and defined exception handling rules.

If the additional criteria are met at step (208), method 200 then proceeds to step (212). If it is determined at step 200 that the additional criteria are not met, then method 200 proceeds to step (210) and the operations as detailed above are performed.

If it is determined at step (208), that the additional criteria are met, method 200 proceeds to step (212), where the requested operation is performed at the local system. Upon the requested read operation being performed, method 200 provides the resulting data to the user.

Through use of the respective systems and methods that have been described herein, read only operations that make use of data stored on remote caches may be: processed without recourse to any data or processing operations that may take place at the master server.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method for determining where a request related to an electronic document received from a client device in a document management system should be processed; the method comprising:
(a) determining whether the request is a read only request that may be processed at a local replicated system;
(b) routing the request to either a master document management server or a local replicated system; and
(c) monitoring the local replicated systems to determine whether subsequent transactions may be processed at the local replicated systems.

2. The method of claim 1, further comprising receiving the request through a web browser.

3. The method of claim 1, further comprising the step of checking to determine whether a previous write operation has been completed before processing the request at the local replicated system.

4. The method of claim 1, wherein the master database and the local replicated system are accessible to one another through a communication network.

5. The method of claim 4, wherein the communication network may be selected from the group comprising the Internet, the Intranet, a wide area network, and a local area network.

6. A computer-readable medium upon which a plurality of instructions are stored, the instructions for performing the steps of the method as claimed in claim 1.

7. A method of processing a request associated with an electronic document in a document management system at a local document management replicated system, the method comprising the steps of:
(a) receiving the request;
(b) determining if the request is a read-only request;
(c) determining if a previous write operation has been completed;
(d) processing the request at the local replicated system where the determinations made at steps (b), (c) are true, and processing the request at a master server where one of the determinations made at steps (b), or (c) are false.

8. The method of claim 7, further comprising receiving the request through a web browser.

9. The method of claim 7, wherein the master database and the local replicated system are accessible to one another through a communication network.

10. The method of claim 9, wherein the communication network may be selected from the group comprising the Internet, the Intranet, a wide area network, and a local area network.

11. A computer-readable medium upon which a plurality of instructions are stored, the instructions for performing the steps of the method as claimed in claim 1.

12. A system for determining where a request related to an electronic document received from a client device in a document management system should be processed; the system comprising:
(a) a memory for storing a plurality of instructions; and
(b) a processor coupled to the memory, said processor configured for:
(i) determining whether the request is a read only request that may be processed at a local replicated system;
(ii) routing the request to either the master document management server or a local replicated system; and
(iii) monitoring the local replicated systems to determine whether subsequent transactions may be processed at the local replicated systems.

13. The method of claim 12, further comprising receiving the request through a web browser.

14. The method of claim 12, further comprising the step of checking to determine whether a previous write operation has been completed before processing the request at the local replicated system.

15. The method of claim 12, wherein the master database and the local replicated system are accessible to one another through a communication network.

16. The method of claim 15, wherein the communication network may be selected from the group comprising the Internet, the Intranet, a wide area network, and a local area network.

17. A system of processing a request associated with an electronic document in a document management system at a remote cache; the system comprising:
(a) a memory for storing a plurality of instructions; and
(b) a processor coupled to the memory, said processor configured for:
(i) receiving the request;
(ii) determining if the request is a read-only request;
(iii) determining if a previous write operation has been completed;
(iv) processing the request at the local replicated system where the determinations made at steps (ii), (iii) are true, and processing the request at a master server where one of the determinations made at steps (ii), or (iii) are false.

18. The system of claim 17, further comprising receiving the request through a web browser.

19. The system of claim 17, further comprising the step of checking to determine whether a previous write operation has been completed before processing the request at the local replicated system.

20. The system of claim 17, wherein the master database and the local replicated system are accessible to one another through a communication network.

21. The system of claim 20, wherein the communication network may be selected from the group comprising the Internet, the Intranet, a wide area network, and a local area network.
